(19) United States
(12) Patent Application Publication
(10) Pub. No.: US 2026/0361641 A1
(43) Pub. Date: Nov. 12, 2026

(54) TERMINAL DEVICES, NETWORK DEVICE, AND METHODS FOR MULTI-PATH COMMUNICATIONS

(71) Applicant: Lenovo (Beijing) Limited, Beijing (CN)

(72) Inventors: Ran Yue, Beijing (CN); Haiming Wang, Beijing (CN); Lianhai Wu, Beijing (CN); Jing Han, Beijing (CN); Min Xu, Beijing (CN); Jie Hu, Beijing (CN)

(73) Assignee: Lenovo (Beijing) Limited, Beijing (CN)

(21) Appl. No.: 19/134,554

(22) PCT Filed: Mar. 7, 2023
(86) PCT No.: PCT/CN2023/080175

§ 371 Date: May 30, 2025

(51) Int. Cl. H04L 45/24

(52) U.S. Cl. CPC H04L 45/24

(57) ABSTRACT

Embodiments of the present disclosure relate to a solution for MP communications. In one aspect of the solution, a terminal device obtains, from a network device, at least one ID of the terminal device associated with an MP operation. The terminal device manages the at least one ID for the MP operation.

### FIELD

Embodiments of the present disclosure generally relate to the field of communication, and in particular to terminal devices, network device, and methods for multi-path (MP) communications.

### BACKGROUND

As the number of mobile devices within wireless networks and the demand for mobile data traffic continue to increase, changes are made to system requirements and architectures to better address current and anticipated demands. For example, some wireless communication networks (e.g., fifth generation (5G) or new radio (NR) networks) may be developed to include user equipment (UE) to network (NW) (U2N) relay communications. In such scenarios, at least one identity (ID) of UE needs to be managed.

### SUMMARY

In general, embodiments of the present disclosure provide a solution for MP communications.

In a first aspect, there is provided a terminal device. The terminal device comprises a processor and a transceiver coupled to the processor. The processor is configured to: obtain, via the transceiver from a network device, at least one ID of the terminal device associated with a multi-path operation; and manage the at least one ID for the multi-path operation.

In a second aspect, there is provided a network device. The network device comprises a processor and a transceiver coupled to the processor. The processor is configured to: transmit, via the transceiver to a terminal device, at least one configuration for at least one ID of the terminal device associated with a multi-path operation; and align the at least one ID for the multi-path operation.

In a third aspect, there is provided a terminal device. The terminal device comprises a processor and a transceiver coupled to the processor. The processor is configured to: operate with multiple paths; and determine at least one of the multiple paths to be maintained or receive a first indication that the at least one of the multiple paths is determined to be maintained from a network device.

In a fourth aspect, there is provided a method performed by a terminal device. The method comprises: obtaining, at a terminal device from a network device, at least one ID of the terminal device associated with a multi-path operation; and managing the at least one ID for the multi-path operation.

In a fifth aspect, there is provided a method performed by a network device. The method comprises: transmitting, from a network device to a terminal device, at least one configuration for at least one ID of the terminal device associated with a multi-path operation; and aligning the at least one ID for the multi-path operation.

In a sixth aspect, there is provided a method performed by a terminal device. The method comprises: operating with multiple paths at a terminal device; and determining at least one of the multiple paths to be maintained or receiving a first indication that the at least one of the multiple paths is determined to be maintained from a network device.

In a seventh aspect, there is provided a computer readable medium. The computer readable medium has instructions stored thereon. The instructions, when executed on at least one processor of a device, causing the device to perform the method of the fourth, fifth or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIGS. 1A, 1B, 1C, 1D, 1E, 1F, 1G and 1H illustrate a schematic diagram of a communication environment in which some embodiments of the present disclosure can be implemented, respectively;

FIG. 2 illustrates a flowchart of a method implemented at a terminal device in accordance with some embodiments of the present disclosure;

FIG. 3 illustrates a flowchart of a method implemented at a network device in accordance with other embodiments of the present disclosure;

FIG. 4 illustrates a flowchart of a method implemented at a terminal device in accordance with some embodiments of the present disclosure; and

FIG. 5 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IOT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

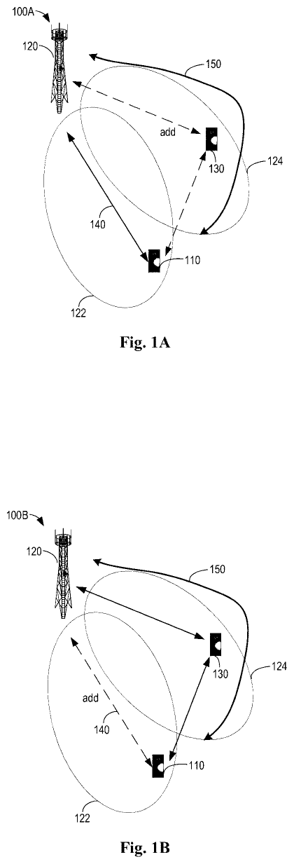

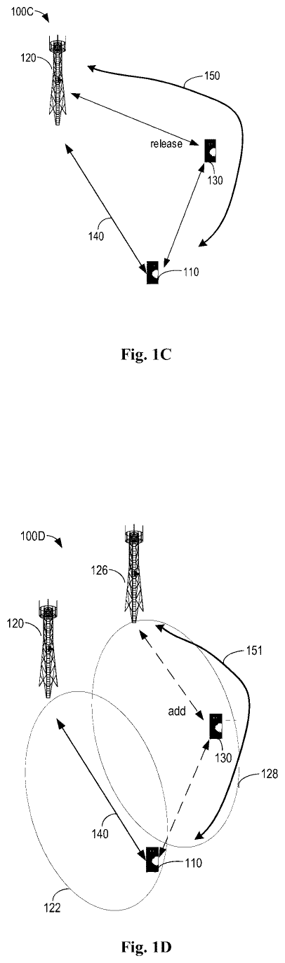

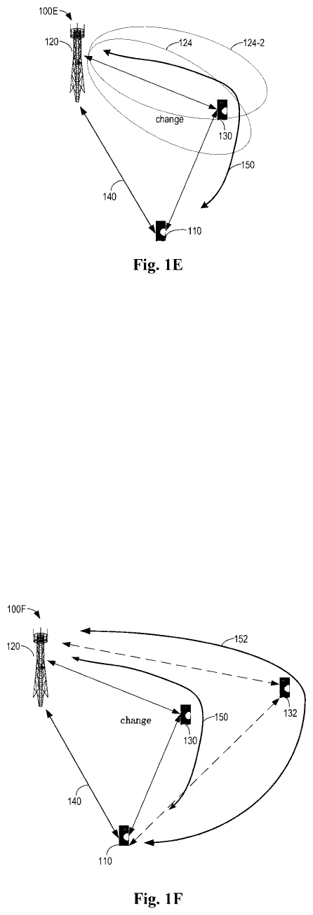

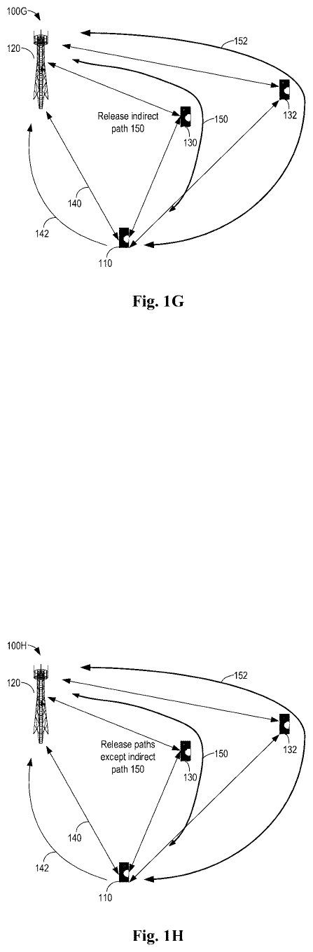

FIGS. 1A, 1B and 1C illustrate schematic diagrams of communication environments 100A, 100B and 100C in which some embodiments of the present disclosure can be implemented. Each of the communication environments 100A, 100B and 100C may comprise a terminal device 110, a network device 120, and a terminal device 130. Hereinafter the terminal devices 110 and 130 may also be referred to as the UE 110 and UE 130, respectively.

The terminal device 110 may be in coverage of a cell 122 of the network device 120. In this case, the terminal device 110 may be connected to the network device 120 using a direct path 140.

In some embodiments, an interface between the terminal device 110 and the network device 120 may be a Uu interface.

As shown in FIG. 1A, in some embodiments, in order to extend cell coverage and provide reachability for cell-edge users (or out-of-coverage users), an indirect path 150 may be established and added after the direct path 140 was established. Thus, the terminal device 110 may be connected to the network device 120 using the indirect path 150 via the terminal device 130. The terminal device 130 is in coverage of a cell 124 of the network device 120. In this case, the terminal device 130 is also referred to as a U2N relay UE, and the terminal device 110 is also referred to as a remote UE. It shall be understood that the cell 122 and the cell 124 can be the same cell or different cell.

In the present disclosure, a direct path may also be referred to as a direct link or direct leg, and an indirect path may also be referred to as an indirect link or indirect leg.

In some embodiments, an interface between the terminal device 130 and the network device 120 may be a Uu interface, and an interface between the terminal device 110 and the terminal device 130 may be a PC5 interface. In such embodiments, a connection between the terminal device 110 and the terminal device 130 may be a PC5-Radio Resource Control (RRC) connection.

As shown in FIG. 1B, in some embodiments, the direct path 140 may be established and added after the indirect path 150 was established.

In the communication environments 100A, 100B and 100C, the terminal device 110 may perform an MP operation. In other words, the terminal device 110 may operate with multiple paths which may comprise the direct path 140 and the indirect path 150, for example. In some embodiments, the MP operation in the communication environments 100A, 100B and 100C is also referred to as intra-gNB MP operation.

In some embodiments, during the MP operation, the terminal device 110 may communicate with the network device 120 using both the direct path 140 and the indirect path 150 concurrently. Alternatively, during the MP operation, the terminal device 110 may communicate with the network device 120 using one of the direct path 140 and the indirect path 150.

In some embodiments, the connection with the terminal device 130 may be determined to be released. Thus, the indirect path 150 may be released, as shown in FIG. 1C. Alternatively, the connection with the network device 120 may be determined to be released. Thus, the direct path 140 may be released. It shall be noted that the cells 122 and 124 are not illustrated in FIG. 1C for brevity.

It is to be understood that the numbers of the network devices and terminal devices are only for ease of understanding without suggesting any limitations. The communication environments 100A, 100B and 100C may include any suitable number or type of the network devices and terminal devices adapted for implementing embodiments of the present disclosure.

FIG. 1D illustrates a schematic diagrams of a communication environment 100D in which some embodiments of the present disclosure can be implemented.

The communication environment 100D is similar to the communication environments 100A, 100B and 100C.

The communication environment 100D is different from the communication environments 100A, 100B and 100C in that in the communication environment 100D, the terminal device 110 is connected to the network device 120 using the direct path 140 and connected to a network device 126 using an indirect path 151 via the terminal device 130. The terminal device 130 is in coverage of a cell 128 of the network device 126.

In the communication environment 100D, the terminal device 110 may perform a MP operation. In other words, the terminal device 110 may operate with multiple paths which may comprise the direct path 140 and the indirect path 151, for example. In some embodiments, the MP operation in the communication environment 100D is also referred to as inter-gNB MP operation.

FIGS. 1E and 1F illustrate schematic diagrams of communication environments 100E and 100F in which some embodiments of the present disclosure can be implemented, respectively.

The communication environments 100E and 100F are similar to the communication environments 100A, 100B and 100C.

The communication environments 100E and 100F are different from the communication environments 100A, 100B and 100C in that in the communication environments 100E and 100F, the terminal device 130 may perform a cell change procedure from the cell 124 to a cell 124-2. In this case, the indirect path 150 may be released or the direct path 140 may be released.

Alternatively, if the indirect path 150 is released, in order to maintain the MP operation, at least one candidate relay UE and at least one other indirect path may be established and added for the MP operation if a predetermined condition is met. The candidate relay UE may be in coverage of the cell 124 or out of coverage of the cell 124. It shall be noted that the cells 122 and 124 are not illustrated in FIG. 1F for brevity.

For example, the candidate relay UE may comprise a terminal device 132. The terminal device 132 may be in coverage of the cell 124 or out of coverage of the cell 124. If the predetermined condition is met, an indirect path 152 may be established and added for the MP operation. Thus, the terminal device 110 may be connected to the network device 120 using the indirect path 152 via the terminal device 132.

In some embodiments, the terminal device 110 may be connected to the network device 120 using multiple direct paths and multiple indirect paths. This will be described with reference to FIGS. 1G and 1H.

FIGS. 1G and 1H illustrate schematic diagrams of communication environments 100G and 100H in which some embodiments of the present disclosure can be implemented, respectively.

In the communication environments 100G and 100H, the terminal device 110 are connected to the network device 120 using direct paths 140 and 142 as well as indirect paths 150 and 152.

In some embodiments, the connection with the terminal device 130 may be determined to be released. Thus, the indirect path 150 may be released, as shown in FIG. 1G.

Alternatively, in some embodiments, the connection with the terminal device 132 and a direct connection with the network device 120 may be determined to be released while the connection with the terminal device 130 may be determined to be maintained. Thus, remaining paths among the multiple paths except the indirect path 150 may be released, as shown in FIG. 1H.

Communications in the communication environments 100A to 100H may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some embodiments, once a direct path (such as the direct path 140) is established, a cell which the terminal device 110 accessed (such as the cell 122) is a primary cell (PCell) of the terminal device 110 and a Cell-Radio Network Temporary Identifier (C-RNTI) of the terminal device 110 may be maintained in a Medium Access Control (MAC) entity of the terminal device 110.

In some embodiments, when an indirect path (such as the direct path 150) is established and added in an MP scenario, the terminal device 110 may be configured with an ID and the ID may be used as the C-RNTI in the PCell.

Thus, there may be two UE IDs from the direct path and the indirect path in the MP scenario if referring to the legacy procedure. While in the legacy procedure, there is only one UE ID which is maintained in the MAC entity.

In view of the above, it needs to discuss how to model one or more UE IDs from the direct path and the indirect path. In addition, it needs to discuss how to manage the one or more UE IDs from the direct path and the indirect path.

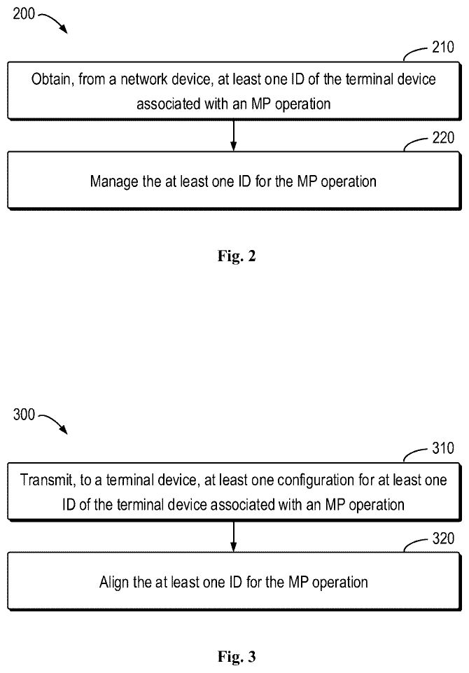

Embodiments of the present disclosure provide a solution for MP communications. In one aspect of the solution, a terminal device obtains, from a network device, at least one ID of the terminal device associated with an MP operation. The terminal device manages the at least one ID for the MP operation. Hereinafter, principle of the present disclosure will be described with reference to FIGS. 2 to 3.

FIG. 2 illustrates a flowchart of a method 200 implemented at a terminal device in accordance with some embodiments of the present disclosure. For the purpose of discussion, the method 200 will be described from the perspective of the terminal device 110 with reference to FIG. 1A, 1B, 1C or 1D.

At block 210, the terminal device 110 obtains, from the network device 120, at least one ID of the terminal device 110 associated with an MP operation.

At block 220, the terminal device 110 manages the at least one ID for the MP operation.

FIG. 3 illustrates a flowchart of a method 300 implemented at a network device in accordance with some embodiments of the present disclosure. For the purpose of discussion, the method 300 will be described from the perspective of the network device 120 with reference to FIG. 1A, 1B, 1C or 1D.

At block 310, the network device 120 transmits, to the terminal device 110, at least one configuration for at least one I) of the terminal device 110 associated with an MP operation.

At block 320, the network device 120 aligns the at least one ID for the MP operation.

In a first solution, during the MP operation, the terminal device 110 may manage only one dedicated ID of the terminal device 110 for the MP operation.

According to the first solution, the terminal device 110 may manage the dedicated ID of the terminal device 110 for an MAC entity of the terminal device 110 associated with the MP operation.

In a second solution, the terminal device 110 may obtain at least one third C-RNTI of the terminal device 110 from the network device 120. Each of the at least one third C-RNTI is associated with one of multiple paths. The terminal device 110 may maintain one of the at least one third C-RNTI as a dedicated ID of the terminal device 110 for the MP operation. The terminal device 110 may suspend the other C-RNTI among the at least one third C-RNTI.

In a third solution, the terminal device 110 may manage an ID of the terminal device 110 for each of multiple paths.

Hereinafter, some embodiments for the first, second and third solutions will be described taking one direct path and one indirect path for example. It shall be noted that multiple direct paths or multiple indirect paths may be applied to the present disclosure.

### Addition of an Indirect Path

### Embodiment #1-1 for the First Solution

For the purpose of discussion, Embodiment #1-1 will be described with reference to FIG. 1A. As shown in FIG. 1A, after the direct path 140 is established, the indirect path 150 is to be established and added for an MP operation.

In Embodiment #1-1, when the direct path 140 is established, the terminal device 110 may obtain, from the network device 120, a C-RNTI of the terminal device 110 in a PCell (for example, the cell 122). For example, the terminal device 110 may obtain the C-RNTI via an RA procedure. The C-RNTI is also referred to as a C-RNTI which is associated with the direct path 140.

When the indirect path 150 is established and added for the MP operation, the terminal device 110 may not obtain an ID of the terminal device 110 from the network device 120.

The terminal device 110 may receive a first configuration for the MP operation from the network device 120. The first configuration may be used to configure the MP operation or indicate to add at least one additional path. The first configuration may comprise a dedicated ID of the terminal device 110 for the MP operation. The terminal device 110 may use the dedicated ID as a C-RNTI of the terminal device 110 for the MP operation.

Upon receiving the first configuration for the MP operation, the terminal device 110 may suspend or release the C-RNTI which was obtained when the direct path 140 was established (i.e., the C-RNTI which is associated with the direct path 140).

When at least one of multiple paths is released, the terminal device 110 may restore one or more of the at least one suspended C-RNTI which is associated with at least one maintained path. For example, when the indirect path 150 is released, the terminal device 110 may restore the suspended C-RNTI which is associated with the direct path 140.

Alternatively, when at least one of multiple paths is released, the terminal device 110 may obtain, from the network device 120, one or more ID of the terminal device for at least one maintained path. For example, when the direct path 140 is released, the terminal device 110 may obtain, from the network device 120, an ID of the terminal device 110 for the indirect path 150. For example, the terminal device 110 may receive relay operation related configurations from the network device 120 via an SL-L2RemoteUE-Config information element (IE). The SL-L2RemoteUE-Config IE may comprise a parameter “sl-UEIdentityRemote” which indicates the C-RNTI to the L2 U2N Remote UE. The terminal device 110 may use a value of the sl-UEIdentityRemote as the C-RNTI in the PCell (for example, the cell 124).

Alternatively, when at least one of multiple paths is released, the terminal device 110 may obtain, from the network device 120, IDs of the terminal device 110 for the multiple paths. For example, the multiple paths comprising the direct path 140 and the indirect path 150 may be released. It means that the terminal device 110 does not operate with the multiple paths. In this case, the terminal device 110 may obtain, from the network device 120, an ID of the terminal device 110 for the direct path 140 and an ID of the terminal device 110 for the indirect path 150.

### Variant of Embodiment #1-1 for the First Solution

For the purpose of discussion, the variant of Embodiment #1-1 will be described with reference to FIG. 1A.

In the variant of Embodiment #1-1, the first configuration for the MP operation may not comprise a dedicated ID of the terminal device 110 for the MP operation.

When the direct path 140 is established, the terminal device 110 may obtain, from the network device 120, a C-RNTI of the terminal device 110 in a PCell (for example, the cell 122). For example, the terminal device 110 may obtain the C-RNTI via an RA procedure. The terminal device 110 may maintain the C-RNTI in the PCell as a dedicated ID of the terminal device 110 for the MP operation. For example, upon receiving the first configuration for the MP operation, the terminal device 110 may maintain the C-RNTI in the PCell as the dedicated ID of the terminal device 110 for the MP operation.

In addition, the terminal device 110 may use the dedicated ID as a C-RNTI of the terminal device 110 for the MP operation.

When at least one of multiple paths is released, the terminal device 110 may obtain, from the network device 120, one or more ID of the terminal device for at least one maintained path. For example, when the direct path 140 is released, the terminal device 110 may obtain, from the network device 120, an ID of the terminal device 110 for the indirect path 150. For example, similar to the Embodiment #1-1, the terminal device 110 may use a value of the sl-UEIdentityRemote as the C-RNTI in the PCell (for example, the cell 124).

### Embodiment #1-2 for the Second Solution

For the purpose of discussion, Embodiment #1-2 will be described with reference to FIG. 1A.

When the direct path 140 is established, the terminal device 110 may obtain, from the network device 120, a C-RNTI of the terminal device 110 in a PCell (for example, the cell 122). For example, the terminal device 110 may obtain the C-RNTI via an RA procedure. The C-RNTI is also referred to as a C-RNTI which is associated with the direct path 140.

When the indirect path 150 is established and added for the MP operation, the terminal device 110 may obtain an ID of the terminal device 110 from the network device 120. For example, the terminal device 110 may use a value of the sl-UEIdentityRemote as the C-RNTI in the PCell (for example, the cell 124). The C-RNTI configured by the sl-UEIdentityRemote is also referred to as a C-RNTI which is associated with the indirect path 150 or a C-RNTI configured by the indirect path 150.

In turn, the terminal device 110 may maintain one of the C-RNTI associated with the direct path 140 and the C-RNTI configured by the indirect path 150 as a dedicated ID of the terminal device 110 for the MP operation. The terminal device 110 may suspend the other C-RNTI.

When the direct path 140 is released or the multiple paths are released, the terminal device 110 may restore the C-RNTI configured by the indirect path 150 and use it as the C-RNTI in the PCell 124.

Alternatively, the terminal device 110 may restore the ID (for example, which is used as C-RNTI) for each of the multiple paths, if configured before MP operation.

### Embodiment #1-3 for the Third Solution

For the purpose of discussion, Embodiment #1-3 will be described with reference to FIG. 1A.

When the direct path 140 is established, the terminal device 110 may obtain, from the network device 120, a C-RNTI of the terminal device 110 in a PCell (for example, the cell 122). For example, the terminal device 110 may obtain the C-RNTI via an RA procedure. The C-RNTI is also referred to as a C-RNTI which is associated with the direct path 140.

When the indirect path 150 is established and added for the MP operation, the terminal device 110 may obtain an ID of the terminal device 110 from the network device 120. For example, the terminal device 110 may use a value of the sl-UEIdentityRemote as the C-RNTI in the PCell (for example, the cell 124). The C-RNTI configured by the sl-UEIdentityRemote is also referred to as a C-RNTI which is associated with the indirect path 150 or a C-RNTI configured by the indirect path 150.

In turn, the terminal device 110 may maintain one C-RNTI of the terminal device 110 for each of the direct path 140 and the indirect path 150. For example, for the direct path 140, the terminal device 110 may maintain the C-RNTI associated with the direct path 140; for the indirect path 150, the terminal device 110 may maintain the C-RNTI associated with the indirect path 150.

Alternatively, the terminal device 110 may perform the UE context management for each of the direct path 140 and the indirect path 150.

Additionally or alternatively, for the direct path 140, the MAC entity of the terminal device 110 may monitor or use one C-RNTI of the terminal device 110 for each of the direct path 140 and the indirect path 150. For example, the MAC entity of the terminal device 110 may monitor Physical Downlink Control Channel (PDCCH) addressed to the C-RNTI associated with the direct path 140, including the C-RNTI MAC CE in the uplink transmission associated with the direct path 140. For another example, the MAC entity of the terminal device 110 may monitor Physical Downlink Control Channel (PDCCH) addressed to the C-RNTI associated with the indirect path 150, including the C-RNTI MAC CE in the uplink transmission associated with the indirect path 150.

### Addition of a Direct Path

### Embodiment #2-1 for the First Solution

For the purpose of discussion, Embodiment #2-1 will be described with reference to FIG. 1B. As shown in FIG. 1B, after the indirect path 150 is established, the direct path 140 is to be established and added for an MP operation.

The terminal device 110 may initiate an RA procedure when adding the direct path 140 for the MP operation.

The terminal device 110 may transmit, to the network device 120, an uplink message scheduled by an RA response message. The uplink message may comprise the C-RNTI configured by the indirect path 150. For example, the uplink message scheduled by the RA response message may be message 3 (Msg3) or the uplink message is transmitted using the associated PUSCH resource of MSGA.

The terminal device 110 may receive, from the network device 120, a downlink message associated with success of the RA procedure. The downlink message may comprise a C-RNTI of the terminal device 110 for the direct path 140. For example, the downlink message may be message 4 (Msg4) or MSGB or a separate message after the transmission of Msg4.

The downlink message may comprise a new MAC control element (CE) format and/or MAC logical channel (LCH) identifier (ID) (LCID) carrying the C-RNTI for the direct path 140 or for the MP operation. Alternatively, the downlink message may comprise a new MAC logical channel (LCH) identifier (ID) (LCID) to indicate the type of the corresponding MAC CE which carries the C-RNTI for the direct path 140 or for the MP operation.

The terminal device 110 may update the C-RNTI configured by the indirect path 150 with the C-RNTI for the direct path 140 (i.e., the C-RNTI obtained via the RA procedure). In other words, the terminal device 110 may replace the C-RNTI configured by the indirect path 150 with the C-RNTI obtained via the RA procedure.

The terminal device 110 may maintain the updated fourth C-RNTI (i.e., the C-RNTI obtained via the RA procedure) as a dedicated ID of the terminal device 110 for the MP operation.

### Embodiment #2-2 for the First Solution or the Second Solution

For the purpose of discussion, Embodiment #2-2 will be described with reference to FIG. 1B. As shown in FIG. 1B, after the indirect path 150 is established, the direct path 140 is to be established and added for an MP operation.

The terminal device 110 may initiate an RA procedure when adding the direct path 140 for the MP operation.

The terminal device 110 may transmit, to the network device 120, an uplink message scheduled by an RA response message. The uplink message may not comprise the C-RNTI configured by the indirect path 150. For example, the uplink message scheduled by the RA response message may be message 3 (Msg3) or the uplink message is transmitted using the associated PUSCH resource of MSGA.

The terminal device 110 may receive, from the network device 120, a downlink message associated with success of the RA procedure. The downlink message may comprise a C-RNTI of the terminal device 110 for the direct path 140. For example, the downlink message may be message 4 (Msg4) or MSGB or a separate message after the transmission of Msg4.

After the RA procedure successfully completes, the terminal device 110 may release the C-RNTI configured by the indirect path 150. The terminal device 110 may maintain the C-RNTI for the direct path 140 (i.e., the C-RNTI obtained via the RA procedure) as a dedicated ID of the terminal device 110 for the MP operation.

### Embodiment #2-3 for the Second Solution

For the purpose of discussion, Embodiment #2-3 will be described with reference to FIG. 1B. As shown in FIG. 1B, after the indirect path 150 is established, the direct path 140 is to be established and added for an MP operation.

The terminal device 110 may suspend the C-RNTI configured by the indirect path 150.

The terminal device 110 may initiate an RA procedure when adding the direct path 140 for the MP operation.

The terminal device 110 may receive, from the network device 120, a downlink message associated with success of the RA procedure. The downlink message may comprise a C-RNTI of the terminal device 110 for the direct path 140. For example, the downlink message may be message 4 (Msg4) or a separate message after the transmission of Msg4.

The terminal device 110 may maintain the C-RNTI for the direct path 140 (i.e., the C-RNTI obtained via the RA procedure) as a dedicated ID of the terminal device 110 for the MP operation.

After the direct path 140 is released or the multiple paths are released, the terminal device 110 may restore the C-RNTI configured by the indirect path 150 and use it as the C-RNTI in the PCell 124.

### Embodiment #2-4 for the Third Solution

For the purpose of discussion, Embodiment #2-4 will be described with reference to FIG. 1B. As shown in FIG. 1B, after the indirect path 150 is established, the direct path 140 is to be established and added for an MP operation.

The terminal device 110 may initiate an RA procedure when adding the direct path 140 for the MP operation.

The terminal device 110 may transmit, to the network device 120, an uplink message scheduled by an RA response message. The uplink message may comprise the C-RNTI configured by the indirect path 150. For example, the uplink message scheduled by the RA response message may be message 3 (Msg3) or the uplink message is transmitted using the associated PUSCH resource of MSGA.

The terminal device 110 may receive, from the network device 120, a downlink message associated with success of the RA procedure. The downlink message may comprise a C-RNTI of the terminal device 110 for the direct path 140. For example, the downlink message may be message 4 (Msg4) or MSGB or a separate message after the transmission of Msg4.

The terminal device 110 may use the C-RNTI obtained via the RA procedure for the direct path 140 after the RA procedure successfully completes.

The terminal device 110 may store the C-RNTI configured by the indirect path 150 for the indirect path 150 and use it for the indirect path 150 rafter the RA procedure successfully completes.

### Embodiment #2-5 for the Third Solution

For the purpose of discussion, Embodiment #2-5 will be described with reference to FIG. 1B. As shown in FIG. 1B, after the indirect path 150 is established, the direct path 140 is to be established and added for an MP operation.

The terminal device 110 may initiate an RA procedure when adding the direct path 140 for the MP operation.

The terminal device 110 may transmit, to the network device 120, an uplink message scheduled by an RA response message. The uplink message may not comprise the C-RNTI configured by the indirect path 150. For example, the uplink message scheduled by the RA response message may be message 3 (Msg3) or the uplink message is transmitted using the associated PUSCH resource of MSGA.

The terminal device 110 may store the C-RNTI obtained via the RA procedure and use it for the direct path 140 after the RA procedure successfully completes.

The terminal device 110 may store the C-RNTI configured by the indirect path 150 for the indirect path 150 and use it for the indirect path 150 after the RA procedure successfully completes.

### Embodiment #2-6 for the Second Solution

For the purpose of discussion, Embodiment #2-4 will be described with reference to FIG. 1B. As shown in FIG. 1B, after the indirect path 150 is established, the direct path 140 is to be established and added for an MP operation.

The terminal device 110 may initiate an RA procedure when adding the direct path 140 for the MP operation.

The terminal device 110 may transmit, to the network device 120, an uplink message scheduled by an RA response message. The uplink message may comprise the C-RNTI configured by the indirect path 150. For example, the uplink message scheduled by the RA response message may be message 3 (Msg3) or the uplink message is transmitted using the associated PUSCH resource of MSGA.

Upon receiving the uplink message, the network device 120 may respond to the terminal device 110 with an indication to indicate the C-RNTI collision (assuming dedicated preamble and/or physical random access channel (PRACH) resource is used, otherwise the network device 120 cannot distinguish the terminal device 110 from terminal devices which are already in the cell 122).

The terminal device 110 may receive, from the network device 120, a downlink message associated with success of the RA procedure. The downlink message may comprise a C-RNTI of the terminal device 110 for the direct path 140. For example, the downlink message may be message 4 (Msg4) or MSGB or a separate message after the transmission of Msg4.

The terminal device 110 may update the C-RNTI configured by the indirect path 150 with the C-RNTI for the direct path 140 (i.e., the C-RNTI obtained via the RA procedure).

The terminal device 110 may maintain the updated fourth C-RNTI (i.e., the C-RNTI obtained via the RA procedure) as a dedicated ID of the terminal device 110 for the MP operation.

Alternatively, upon receiving the indication to indicate the C-RNTI collision, the terminal device 110 may a new RA procedure without including the C-RNTI configured by the indirect path 150 in Msg3.

The terminal device 110 may receive, from the network device 120, a downlink message associated with success of the RA procedure. The downlink message may comprise a C-RNTI of the terminal device 110 for the direct path 140.

The terminal device 110 may update the C-RNTI configured by the indirect path 150 with the C-RNTI for the direct path 140 (i.e., the C-RNTI obtained via the RA procedure).

The terminal device 110 may maintain the updated fourth C-RNTI (i.e., the C-RNTI obtained via the RA procedure) as a dedicated ID of the terminal device 110 for the MP operation.

### Embodiment #2-7 for the First, Second or Third Solution

In Embodiment #2-7, a PCell change procedure is applied or is not applied.

When a path is added for MP operation, when at least one of the multiple paths is released, or when the multiple paths are released, the terminal device 110 may receive, from the network device 120, a reconfiguration of a C-RNTI of the terminal device 110 for the indirect path 150.

For example, the terminal device 110 may receive relay operation related configurations from the network device 120 via an SL-L2RemoteUE-Config IE. The SL-L2RemoteUE-Config IE may comprise a parameter “sl-UEIdentityRemote” which indicates the C-RNTI to the L2 U2N Remote UE. The terminal device 110 may use a value of the sl-UEIdentityRemote as the C-RNTI in the PCell (for example, the cell 124). In other words, reconfiguration of sl-UEIdentityRemote is allowed.

### Release of a Direct Path

### Embodiment #3-1 for the First or Second Solution

In Embodiment #3-1, when the direct path 140 is released, the terminal device 110 may receive, from the network device 120, a reconfiguration of a C-RNTI of the terminal device 110 for the indirect path 150.

For example, the terminal device 110 may receive relay operation related configurations from the network device 120 via an SL-L2RemoteUE-Config IE. The SL-L2RemoteUE-Config IE may comprise a parameter “sl-UEIdentityRemote” which indicates the C-RNTI to the L2 U2N Remote UE. The terminal device 110 may use a value of the sl-UEIdentityRemote as the C-RNTI in the PCell (for example, the cell 124). In other words, reconfiguration of sl-UEIdentityRemote is allowed.

Alternatively, the terminal device 110 may maintain the C-RNTI in the PCell 122 as a C-RNTI for the indirect path 150.

It will be understood that the embodiments described above may mainly be based on a terminal device. Hereinafter, some embodiments which are based on one or more network devices will be described. Such embodiments will be described taking one direct path and one indirect path for example. It shall be noted that multiple direct paths or multiple indirect paths may be applied to the present disclosure.

### Addition of an Indirect Path

### Embodiment #4-1 for the First Solution

For the purpose of discussion, Embodiment #4-1 will be described with reference to FIG. 1A. As shown in FIG. 1A, after the direct path 140 is established, the indirect path 150 is to be established and added for an MP operation.

The network device 120 may manage a first network unit and a second network unit. For example, each of the first network unit and the second network unit may be a distributed unit (DU) managed by a centralized unit (CU). The first network unit may manage a first path and the second network unit may manage a second path. For example, the first network unit may manage the direct path 140 and the second network unit may manage the indirect path 150.

The first configuration for the MP operation may be determined by a network unit managing the direct path 140, such as the first network unit. In order to align the at least one ID of the terminal device 110 for the MP operation, the network device 120 may transmit, from the first network unit to the second network unit, a first ID of the terminal device 110 for the direct path 140. The network device 120 may transmit, the first ID of the terminal device 110 for the direct path 140 via one of the following: Xn interface, F1 interface, or E1 interface. In turn, the second network unit may use the first ID of the terminal device 110 for the direct path 140 as an ID of the terminal device 110 for the indirect path 150. For example, the first ID of the terminal device 110 for the direct path 140 may be a C-RNTI of the terminal device 110.

Alternatively, the first configuration for the MP operation may be determined by a network unit managing the indirect path 150, such as the second network unit. In order to align the at least one ID of the terminal device 110 for the MP operation, the network device 120 may transmit, from the second network unit to the first network unit, a second ID of the terminal device 110 for the indirect path 150. The network device 120 may transmit, the second ID of the terminal device 110 for the indirect path 150 via one of the following: Xn interface, F1 interface, or E1 interface. In turn, the first network unit may use the second ID of the terminal device 110 for the indirect path 150 as an ID of the terminal device 110 for the direct path 140. For example, the second ID of the terminal device 110 for the indirect path 150 may be a C-RNTI of the terminal device 110.

### Embodiment #4-2 for the Second Solution

For the purpose of discussion, Embodiment #4-2 will be described with reference to FIG. 1A. As shown in FIG. 1A, after the direct path 140 is established, the indirect path 150 is to be established and added for an MP operation.

Similar to the Embodiment #4-1, in Embodiment #4-2, in order to align the at least one ID of the terminal device 110 for the MP operation, the network device 120 may transmit, from the first network unit to the second network unit, a first ID of the terminal device 110 for the direct path 140. The network device 120 may transmit, the first ID of the terminal device 110 for the direct path 140 via one of the following: Xn interface, F1 interface, or E1 interface.

In turn, the second network unit may configure the terminal device 110 with the first ID of the terminal device 110 for the direct path 140. Then, the second network unit may use the first ID to manage the terminal device 110 and communicate with the terminal device 110.

For example, the second network unit may transmit relay operation related configurations to the terminal device 110 via an SL-L2RemoteUE-Config IE. The SL-L2RemoteUE-Config IE may comprise a parameter “sl-UEIdentityRemote” which indicates the C-RNTI to the L2 U2N Remote UE. The terminal device 110 may use a value of the sl-UEIdentityRemote as the C-RNTI in the PCell (for example, the cell 124).

Alternatively, in order to align the at least one ID of the terminal device 110 for the MP operation, the network device 120 may transmit, from the second network unit to the first network unit, a second ID of the terminal device 110 for the indirect path 150. The network device 120 may transmit, the second ID of the terminal device 110 for the indirect path 150 via one of the following: Xn interface, F1 interface, or E1 interface.

In turn, the first network unit may configure the terminal device 110 with the second ID of the terminal device 110 for the indirect path 150. Then, the first network unit may use the second ID to manage the terminal device 110 and communicate with the terminal device 110.

### Embodiment #4-3 for the First Solution

For the purpose of discussion, Embodiment #4-3 will be described with reference to FIG. 1D. As shown in FIG. 1D, after the direct path 140 is established, the indirect path 151 is to be established and added for an MP operation. The terminal device 110 is connected to the network device 120 using the direct path 140 and connected to the network device 126 using the indirect path 151 via the terminal device 130. The terminal device 130 is in coverage of the cell 128 of the network device 126.

One of the network device 120 and the network device 126 may determine the addition of one path to support MP operation. For example, the network device 120 may determine the addition of one path to support MP operation. In order to align the at least one ID of the terminal device 110 for the MP operation, the network device 120 may transmit, to the network device 126, a first ID of the terminal device 110 for the direct path 140. The network device 120 may transmit, the first ID of the terminal device 110 for the direct path 140 via a signaling over Xn interface. In turn, the network device 126 may use the first ID of the terminal device 110 for the direct path 140 as an ID of the terminal device 110 for the indirect path 151. For example, the first ID of the terminal device 110 for the direct path 140 may be a C-RNTI of the terminal device 110.

Alternatively, the network device 126 may determine the addition of one path to support MP operation. In order to align the at least one ID of the terminal device 110 for the MP operation, the network device 126 may transmit, to the network device 120, a second ID of the terminal device 110 for the indirect path 151. The network device 126 may transmit, the second ID of the terminal device 110 for the indirect path 151 via a signaling over Xn interface. In turn, the network device 120 may use the second ID of the terminal device 110 for the indirect path 151 as an ID of the terminal device 110 for the direct path 140. For example, the second ID of the terminal device 110 for the indirect path 151 may be a C-RNTI of the terminal device 110.

### Embodiment #4-4 for the Second Solution

For the purpose of discussion, Embodiment #4-4 will be described with reference to FIG. 1D. As shown in FIG. 1D, after the direct path 140 is established, the indirect path 151 is to be established and added for an MP operation.

Similar to the Embodiment #4-3, in Embodiment #4-4, the network device 120 may determine the addition of one path to support MP operation. In order to align the at least one ID of the terminal device 110 for the MP operation, the network device 120 may transmit, to the network device 126, a first ID of the terminal device 110 for the direct path 140. The network device 120 may transmit, the first ID of the terminal device 110 for the direct path 140 via a signaling over Xn interface.

In turn, the network device 126 may configure the terminal device 110 with the first ID of the terminal device 110 for the direct path 140. Then, the network device 126 may use the first ID to manage the terminal device 110 and communicate with the terminal device 110.

For example, the network device 126 may transmit relay operation related configurations to the terminal device 110 via an SL-L2RemoteUE-Config IE. The SL-L2RemoteUE-Config IE may comprise a parameter “sl-UEIdentityRemote” which indicates the C-RNTI to the L2 U2N Remote UE. The terminal device 110 may use a value of the sl-UEIdentityRemote as the C-RNTI in the PCell (for example, the cell 128).

### Embodiment #4-5 for the First Solution

For the purpose of discussion, Embodiment #4-5 will be described with reference to FIG. 1D. As shown in FIG. 1D, after the direct path 140 is established, the indirect path 151 is to be established and added for an MP operation.

In order to align the at least one ID of the terminal device 110 for the MP operation, the network device 120 may receive, from the network device 126, a request for a first ID of the terminal device 110 for the direct path 140. In turn, the network device 120 may transmit, to the network device 126, a response to the request. The response comprises the first ID.

In turn, the network device 126 may configure the terminal device 110 with the first ID. Then, the network device 126 may use the first ID to manage the terminal device 110 and communicate with the terminal device 110.

For example, the network device 126 may transmit relay operation related configurations to the terminal device 110 via an SL-L2RemoteUE-Config IE. The SL-L2RemoteUE-Config IE may comprise a parameter “sl-UEIdentityRemote” which indicates the C-RNTI to the L2 U2N Remote UE. The terminal device 110 may use a value of the sl-UEIdentityRemote as the C-RNTI in the PCell (for example, the cell 128).

As described with reference to FIGS. 1E to 1H, at least one indirect path may be changed or released, or at least one direct path may be released. In this situation, the UE behavior needs to be discussed.

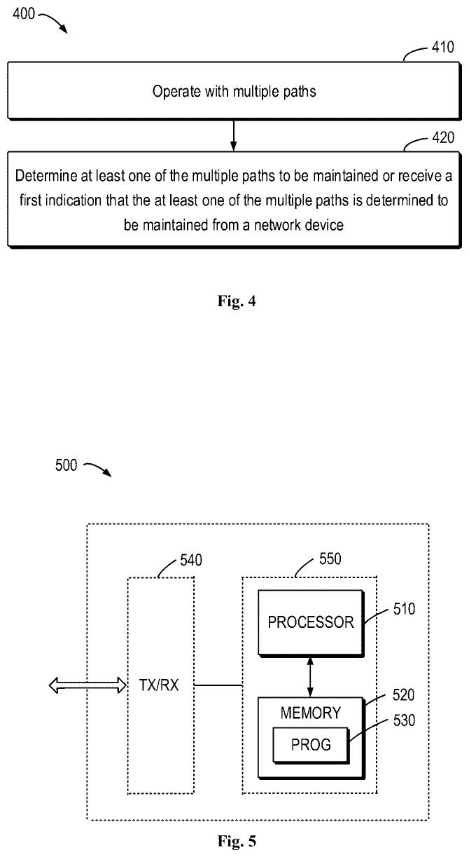

In view of the above, in another aspect of the solution for MP communications, a terminal device operates with multiple paths. In turn, the terminal device determines at least one of the multiple paths to be maintained or receives a first indication that the at least one of the multiple paths is determined to be maintained from a network device. Hereinafter, principle of the present disclosure will be described with reference to FIG. 4.

FIG. 4 illustrates a flowchart of a method 400 implemented at a terminal device in accordance with some embodiments of the present disclosure. For the purpose of discussion, the method 400 will be described from the perspective of the terminal device 110 with reference to FIGS. 1E, 1F, 1G, or 1H.

At block 410, the terminal device 110 operates with multiple paths.

At block 420, the terminal device 110 determines at least one of the multiple paths to be maintained.

Alternatively, the network device 120 determines at least one of the multiple paths to be maintained. In turn, the network device 120 transmits, to the terminal device 110, a first indication that the at least one of the multiple paths is determined to be maintained. Accordingly, the terminal device 110 receives the first indication that the at least one of the multiple paths is determined to be maintained from the network device 120.

Hereinafter, some embodiments will be described by taking the terminal device 110 performs the determination for example. Such embodiments may be applied to scenarios where the network device 120 performs the determination.

In some embodiments, based on determining the at least one of the multiple paths to be maintained, the terminal device 110 may transmit a second indication to the network device 120. The second indication may indicate that the at least one of the multiple paths is maintained or the multiple paths are released.

In some embodiments, the second indication may indicate a cause associated with one of the following: the at least one of the multiple paths is maintained or the multiple paths are released.

In some embodiments, the terminal device 110 may determine the second indication based on an indication received from the terminal device 130. For example, the terminal device 110 may determine the cause in the second indication based on the indication received from the terminal device 130.

In some embodiments, the terminal device 110 may receive a NotificationMessageSidelink message from the terminal device 130.

In some embodiments, the NotificationMessageSidelink message may comprise a HO related indication indicating that HO is performed by the terminal device 130. For example, the NotificationMessageSidelink message may comprise an indicationType which is set as relayUE-HO. Upon receiving the NotificationMessageSidelink message, the terminal device 110 may determine the cause in the second indication to be “a cell change of the terminal device 130” or “HO of the terminal device 130”.

Alternatively, in some embodiments, the NotificationMessageSidelink message may comprise an RLF related indication indicating that a Radio Link Failure (RLF) occurs at the terminal device 130. For example, the NotificationMessageSidelink message may comprise an indicationType which is set as relayUE-Uu-RLF. Upon receiving the NotificationMessageSidelink message, the terminal device 110 may determine the cause in the second indication to be “RLF of the terminal device 130”.

Alternatively, in some embodiments, the terminal device 110 may determine the second indication based on determining that no other indirect path is available. In such embodiments, the cause in the second indication may be “no other indirect path being available”. For example, if there is no other indirect path is available in the cell 124 in FIG. 1E, the terminal device 110 may determine the second indication that indicates no other indirect path is available.

In some embodiments, the second indication may be included in one of the following: an RRC message, a MAC Protocol Data Unit (PDU) or a MAC CE or uplink control information (UCI).

Hereinafter, some embodiments of the second indication will described with reference to FIGS. 1E, 1G and 1H.

In some embodiments, in the communication environment 100E as shown in FIG. 1E, if the terminal device 130 performs a cell change procedure, the terminal device 110 may determine to maintain the connection between the terminal device 110 and the terminal device 130. In such embodiments, the second indication may indicate one of the following: the direct path 140 is released, or the indirect path 150 is maintained.

Alternatively, the terminal device 110 may determine to maintain the direct path 140. In such embodiments, the second indication may indicate one of the following:
the multiple paths are released,
the direct path 140 is maintained,
the indirect path 150 is released, or
the connection between the terminal device 110 and the terminal device 130 is released.

In some embodiments, in the communication environment 100G as shown in FIG. 1G, the terminal device 110 may determine to release at least one of the indirect paths 150 and 152. For example, the terminal device 110 may determine to release the indirect path 150. In such embodiments, the second indication may indicate one of the following:
the connection between the terminal device 110 and the terminal device 130 is released,
the indirect path 150 is released, or
remaining paths among the multiple paths except the indirect path 150 are maintained (i.e., the direct paths 140 and 142 as well as the indirect path 152 are maintained).

In some embodiments, in the communication environment 100H as shown in FIG. 1H, the terminal device 110 may determine to maintain at least one of the indirect paths 150 and 152 and release remaining paths among the multiple paths. For example, the terminal device 110 may determine to maintain the indirect path 150 and release the direct paths 140 and 142 as well as the indirect path 152. In such embodiments, the second indication may indicate one of the following:
the connection between the terminal device 110 and the terminal device 130 is maintained,
the indirect path 150 is maintained, or
remaining paths among the multiple paths except the indirect path 150 are released (i.e., the direct paths 140 and 142 as well as the indirect path 152 are released).

In some embodiments, considering the potential benefit of MP operation, it is better to maintain the MP configuration if possible. Then, change of an indirect path in advance may be needed. A conditional change of the indirect path may be considered to further enhance the continuity in MP scenario.

In such embodiments, the terminal device 110 may change an indirect path among the multiple paths based on determining at least one predetermined condition is met.

In some embodiments, the at least one predetermined condition may comprise signal quality on a second sidelink between the terminal device 110 and a candidate terminal device (for example, the terminal device 132 in FIG. 1F) is better than a quality threshold. Additionally, the at least one predetermined condition may comprise one of the following:
a cell change of a second terminal device (for example, the terminal device 130) is performed, the second terminal device communicating with the terminal device 110 via a first sidelink,
handover of the second terminal device is performed, or
an RLF of the second terminal device occurs.

In some embodiments, the at least one predetermined condition may comprise: first signal quality on a second sidelink between the terminal device 110 and a candidate terminal device is better than second signal quality on a first sidelink between the terminal device 110 and a second terminal device. In some embodiments, the candidate terminal device and the second terminal device may be located in the same cell.

For example, in the communication environment 100F in FIG. 1F, the terminal device 130 is communicating with the terminal device 110 via a first sidelink. If signal quality on a sidelink between the terminal device 110 and the terminal device 132 is better than a quality threshold, the terminal device 110 may change the indirect path from the indirect path 150 to the indirect path 152. Alternatively, if signal quality on a sidelink between the terminal device 110 and the terminal device 132 is better than signal quality on a sidelink between the terminal device 110 and the terminal device 130, the terminal device 110 may change the indirect path from the indirect path 150 to the indirect path 152.

In some embodiments, the at least one predetermined condition may be configured from a PCell (such as the cell 122) to the terminal device 110. In such embodiments, the condition may be transmitted between DUs if the multiple paths are intra-gNB multiple paths. Alternatively, the condition may be transmitted between CUs/DUs if the multiple paths are inter-gNB multiple paths.

In some embodiments, based on the changing of the indirect path, the terminal device 110 may transmit a third indication to the network device 120. The third indication may indicate one of the following:
at least one direct path among the multiple paths is maintained,
the multiple paths are maintained with the indirect path being changed,
at least one indirect path among the multiple paths is maintained, or
at least one changed indirect path among the multiple paths is maintained.

It shall be understood that although some embodiments of the method 400 have been described with reference to FIGS. 1E, 1F, 1G, or 1H. Such embodiments of the method 400 may be applied to the method 200 or combined with some embodiments of the method 200.

FIG. 5 illustrates a simplified block diagram of an apparatus 500 that is suitable for implementing embodiments of the present disclosure. The apparatus 500 can be considered as a further example implementation of the terminal device 110 or the network device 120 as shown in FIGS. 1A to 1H. Accordingly, the apparatus 500 can be implemented at or as at least a part of the terminal device 110 or the network device 120.

As shown, the apparatus 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the apparatus 500 to operate in accordance with the embodiments of the present disclosure, as discussed herein with reference to FIGS. 1A to 1H and 2 to 4. The embodiments herein may be implemented by computer software executable by the processor 510 of the apparatus 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the apparatus 500, there may be several physically distinct memory modules in the apparatus 500. The processor 510 may be of any type suitable to the local technical network, and may include one or more of general purpose computers, special purpose computers, microprocessors, digital signal processors (DSPs) and processors based on multicore processor architecture, as non-limiting examples. The apparatus 500 may have multiple processors, such as an application specific integrated circuit chip that is slaved in time to a clock which synchronizes the main processor.

In summary, embodiments of the present disclosure may provide the following solutions.

Clause 1. A terminal device, comprising: a processor; and a transceiver coupled to the processor, wherein the processor is configured to: obtain, via the transceiver from a network device, at least one identity (ID) of the terminal device associated with a multi-path operation; and manage the at least one ID for the multi-path operation.

Clause 2. The terminal device of Clause 1, In some embodiments, the processor is caused to obtain the at least one ID by: receiving, via the transceiver from the network device, a first configuration for the multi-path operation, the first configuration comprising a dedicated ID of the terminal device for the multi-path operation.

Clause 3. The terminal device of Clause 2, wherein the processor is further caused to: obtain, via the transceiver from the network device, at least one first Cell-Radio Network Temporary Identifier (C-RNTI) of the terminal device, each of the at least one first C-RNTI is associated with one of multiple paths; and the processor is caused to manage the at least one ID by: in response to receiving the first configuration for the multi-path operation, suspending the at least one first C-RNTI.

Clause 4. The terminal device of Clause 3, wherein the multi-path operation comprises release of at least one of the multiple paths; and the processor is caused to manage the at least one ID by one of the following: restoring one or more of the at least one first suspended C-RNTI which is associated with at least one maintained path; obtaining, via the transceiver from the network device, one or more ID of the terminal device for the at least one maintained path; or obtaining, via the transceiver from the network device, IDs of the terminal device for the multiple paths.

Clause 5. The terminal device of Clause 1, wherein: the processor is caused to obtain the at least one ID by: obtaining, via the transceiver from the network device, a second Cell-Radio Network Temporary Identifier (C-RNTI) of the terminal device in a primary cell; and the processor is caused to manage the at least one ID by: maintaining the second C-RNTI as a dedicated ID of the terminal device for the multi-path operation.

Clause 6. The terminal device of Clause 2 or 5, wherein the processor is caused to manage the at least one ID by: using the dedicated ID as a Cell-Radio Network Temporary Identifier (C-RNTI) of the terminal device for the multi-path operation.

Clause 7. The terminal device of Clause 1, wherein the processor is caused to manage the at least one ID by: managing an ID of the terminal device for a Medium Access Control (MAC) entity of the terminal device associated with the multi-path operation.

Clause 8. The terminal device of Clause 1, wherein the processor is caused to obtain the at least one ID by: obtaining, via the transceiver from the network device, at least one third Cell-Radio Network Temporary Identifier (C-RNTI) of the terminal device, each of the at least one third C-RNTI is associated with one of multiple paths; and the processor is caused to manage the at least one ID by: maintaining one of the at least one third C-RNTI as a dedicated ID of the terminal device for the multi-path operation; and suspending the other C-RNTI among the at least one third C-RNTI.

Clause 9. The terminal device of Clause 1, wherein the processor is caused to manage the at least one ID by: managing an ID of the terminal device for each of multiple paths.

Clause 10. The terminal device of Clause 1, wherein the multi-path operation comprises addition of a first path; and the processor is caused to obtain the at least one ID by: transmitting, via the transceiver to the network device, an uplink message scheduled by a random access response message, the uplink message comprising a fourth Cell-Radio Network Temporary Identifier (C-RNTI) of the terminal device configured by a second path; and receiving, via the transceiver from the network device, a downlink message associated with success of a random access procedure, the downlink message comprising a fifth C-RNTI of the terminal device for the first path.

Clause 11. The terminal device of Clause 10, wherein the processor is caused to manage the at least one ID by: updating the fourth C-RNTI with the fifth C-RNTI; and maintaining the updated fourth C-RNTI as a dedicated ID of the terminal device for the multi-path operation.

Clause 12. The terminal device of Clause 1, wherein the multi-path operation comprises addition of a first path; the processor is caused to obtain the at least one ID by: receiving, via the transceiver from the network device, a downlink message associated with success of a random access procedure, the downlink message comprising a fifth Cell-Radio Network Temporary Identifier (C-RNTI) of the terminal device for the first path.

Clause 13. The terminal device of Clause 12, wherein the processor is caused to manage the at least one ID by: maintaining the fifth C-RNTI as a dedicated ID of the terminal device for the multi-path operation; and suspending a fourth C-RNTI of the terminal device configured by a second path.

Clause 14. The terminal device of Clause 1, wherein the multi-path operation comprises addition of a first path; the processor is caused to obtain the at least one ID by: transmitting, via the transceiver to the network device, an uplink message scheduled by a random access response message, the uplink message comprising a fourth Cell-Radio Network Temporary Identifier (C-RNTI) of the terminal device configured by a second path; and receiving, via the transceiver from the network device, a downlink message associated with success of a random access procedure, the downlink message comprising a fifth C-RNTI of the terminal device for the first path; and the processor is caused to manage the at least one ID by: using the fourth C-RNTI for the second path; and using the fifth C-RNTI for the first path.

Clause 15. The terminal device of Clause 1, wherein the multi-path operation comprises addition of a first path; the processor is caused to obtain the at least one ID by: obtaining, via the transceiver from the network device, a fourth Cell-Radio Network Temporary Identifier (C-RNTI) of the terminal device configured by a second path; and receiving, via the transceiver from the network device, a random access response message comprising an ID of the terminal device for the first path; and the processor is caused to manage the at least one ID by: using the fourth C-RNTI for the second path; and using the ID of the terminal device as a fifth C-RNTI for the first path after a random access procedure successfully completes.

Clause 16. The terminal device of Clause 1, wherein the processor is caused to obtain the at least one ID by: receiving, via the transceiver from the network device, a reconfiguration of a Cell-Radio Network Temporary Identifier (C-RNTI) of the terminal device for an indirect path.

Clause 17. A network device, comprising: a processor; and a transceiver coupled to the processor, wherein the processor is configured to: transmit, via the transceiver to a terminal device, at least one configuration for at least one identity (ID) of the terminal device associated with a multi-path operation; and align the at least one ID for the multi-path operation.

Clause 18. The network device of Clause 17, wherein the processor is caused to align the at least one ID for the multi-path operation by: transmitting, via the transceiver, from a first network unit managing a first path to a second network unit managing a second path, a first ID of the terminal device for the first path, the network device managing the first and second network units.

Clause 19. The network device of Clause 17, wherein the processor is caused to align the at least one ID for the multi-path operation by: transmitting, via the transceiver, from the network device managing a first path to a further network device managing a second path, a first ID of the terminal device for the first path.

Clause 20. The network device of Clause 17, wherein the processor is caused to align the at least one ID for the multi-path operation by: receiving, via the transceiver from a further network device managing a second path, a request for a first ID of the terminal device for a first path managed by the network device; and transmitting, via the transceiver to the further network device, a response to the request, the response comprising the first ID.

Clause 21. A terminal device, comprising: a processor; and a transceiver coupled to the processor, wherein the processor is configured to: operate with multiple paths; and determine at least one of the multiple paths to be maintained or receive a first indication that the at least one of the multiple paths is determined to be maintained from a network device.

Clause 22. The terminal device of Clause 21, wherein the processor is further caused to: based on determining the at least one of the multiple paths to be maintained, transmit, via the transceiver to the network device, a second indication that the at least one of the multiple paths is maintained or the multiple paths are released.

Clause 23. The terminal device of Clause 22, wherein the second indication indicates a cause associated with one of the following: the at least one of the multiple paths is maintained or the multiple paths are released.

Clause 24. The terminal device of Clause 23, wherein the cause comprises one of the following: a cell change of a second terminal device communicating with the terminal device via a first sidelink, no other indirect path being available, handover of the second terminal device, or a Radio Link Failure of the second terminal device.

Clause 25. The terminal device of Clause 22, wherein: the multiple paths comprise a direct path and an indirect path; the processor is caused to determine to maintain a first connection between the terminal device and a second terminal device, the first connection being associated with the indirect path; and the second indication indicates one of the following: the direct path is released, or the indirect path is maintained.

Clause 26. The terminal device of Clause 22, wherein: the multiple paths comprise a direct path and an indirect path; the processor is caused to determine to maintain the direct path; and the second indication indicates one of the following: the multiple paths are released,
the direct path is maintained, the indirect path is released, or a first connection between the terminal device and a second terminal device is released.

Clause 27. The terminal device of Clause 22, wherein: the multiple paths comprise multiple direct paths and multiples indirect paths; the processor is caused to determine to release at least one of the indirect paths; and the second indication indicates one of the following: at least one connection between the terminal device and at least one second terminal device is released, the at least one connection being associated with the at least one of the indirect paths, the at least one of the indirect paths is released, or remaining paths among the multiple paths except the at least one of the indirect paths are maintained.

Clause 28. The terminal device of Clause 22, wherein: the multiple paths comprise multiple direct paths and multiples indirect paths; the processor is caused to determine to maintain at least one of the indirect paths; and the second indication indicates one of the following: at least one connection between the terminal device and at least one second terminal device is maintained, the at least one connection being associated with the at least one of the indirect paths, the at least one of the indirect paths is maintained, or remaining paths among the multiple paths except the at least one of the indirect paths are released.

Clause 29. The terminal device of Clause 21, wherein the processor is further caused to: change an indirect path among the multiple paths based on determining at least one predetermined condition is met.

Clause 30. The terminal device of Clause 29, wherein the at least one predetermined condition comprises: signal quality on a second sidelink between the terminal device and a candidate terminal device is better than a quality threshold, and one of the following: a cell change of a second terminal device is performed, the second terminal device communicating with the terminal device via a first sidelink, handover of the second terminal device is performed, or a Radio Link Failure of the second terminal device occurs.

Clause 31. The terminal device of Clause 29, wherein the at least one predetermined condition comprises: first signal quality on a second sidelink between the terminal device and a candidate terminal device is better than second signal quality on a first sidelink between the terminal device and a second terminal device, the indirect path comprises the first sidelink.

Clause 32. The terminal device of Clause 30 or 31, wherein the candidate terminal device and the second terminal device are located in the same cell.

Clause 33. The terminal device of Clause 29, wherein the processor is further caused to: based on the changing of the indirect path, transmit a third indication via the transceiver to the network device, the third indication indicating one of the following: at least one direct path among the multiple paths is maintained, the multiple paths are maintained with the indirect path being changed, at least one indirect path among the multiple paths is maintained, or at least one changed indirect path among the multiple paths is maintained.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1-15. (canceled)

16. A user equipment (UE) for wireless communication, comprising:
at least one memory; and
at least one processor coupled with the at least one memory and operable to cause the UE to:
obtain at least one identity (ID) of the UE associated with a multi-path operation; and
manage the at least one ID for the multi-path operation.

17. The UE of claim 16, wherein to obtain the at least one ID, the at least one processor is operable to cause the UE to:
obtain a cell-radio network temporary identifier (C-RNTI) of the UE in a primary cell.

18. The UE of claim 17, wherein the at least one processor is operable to cause the UE to:
maintain the C-RNTI as a dedicated ID of the UE for the multi-path operation.

19. The UE of claim 16, wherein the at least one ID is not obtained from a network device.

20. The UE of claim 16, wherein to obtain the at least one ID, the at least one processor is operable to cause the UE to:
receive a first configuration for the multi-path operation, the first configuration comprising a dedicated ID of the UE for the multi-path operation.

21. The UE of claim 16, wherein to manage the at least one ID, the at least one processor is operable to cause the UE to:
manage the ID of the UE for a medium access control (MAC) entity of the UE associated with the multi-path operation.

22. The UE of claim 16, wherein the at least one processor is operable to cause the UE to:
obtain at least one cell-radio network temporary identifier (C-RNTI) of the UE, wherein each of the at least one C-RNTI is associated with one of multiple paths;
maintain the at least one C-RNTI as a dedicated ID of the UE for the multi-path operation; and
suspend one or more other C-RNTI.

23. The UE of claim 16, wherein to manage the at least one ID, the at least one processor is operable to cause the UE to:
manage an ID of the UE for each of multiple paths.

24. The UE of claim 16, wherein the multi-path operation comprises an addition of a first path, and wherein to obtain the at least one ID, the at least one processor is operable to cause the UE to:
transmit an uplink message scheduled by a random access response message, the uplink message comprising a first cell-radio network temporary identifier (C-RNTI) of the UE configured by a second path; and
receive a downlink message associated with success of a random access procedure, the downlink message comprising a second C-RNTI of the UE for the first path.

25. The UE of claim 16, wherein the multi-path operation comprises addition of a first path, and wherein to obtain the at least one ID, the at least one processor is operable to cause the UE to:
receive a downlink message associated with success of a random access procedure, the downlink message comprising a cell-radio network temporary identifier (C-RNTI) of the UE for the first path.

26. The UE of claim 16, wherein the multi-path operation comprises addition of a first path, and wherein to obtain the at least one ID comprises to:
transmit an uplink message scheduled by a random access response message, the uplink message comprising a first cell-radio network temporary identifier (C-RNTI) of the UE configured by a second path;
receive a downlink message associated with success of a random access procedure, the downlink message comprising a second C-RNTI of the UE for the first path;
use the first C-RNTI for the second path; and
use the second C-RNTI for the first path.

27. The UE of claim 16, wherein the multi-path operation comprises addition of a first path, and wherein the at least one processor is operable to cause the UE to:
obtain a first cell-radio network temporary identifier (C-RNTI) of the UE configured by a second path;
receive a random access response message comprising an ID of the UE for the first path;
use the first C-RNTI for the second path; and
use the ID of the UE as a second C-RNTI for the first path after a random access procedure successfully completes.

28. The UE of claim 16, wherein to obtain the at least one ID, the at least one processor is operable to cause the UE to:
receive a reconfiguration of a cell-radio network temporary identifier (C-RNTI) of the UE for an indirect path.

29. A method performed by a user equipment (UE), the method comprising:
obtaining at least one identity (ID) of the UE associated with a multi-path operation; and
managing the at least one ID for the multi-path operation.

30. The method of claim 29, further comprising:
obtaining a cell-radio network temporary identifier (C-RNTI) of the UE in a primary cell.

31. The method of claim 30, further comprising:
maintaining the C-RNTI as a dedicated ID of the UE for the multi-path operation.

32. The method of claim 29, wherein the at least one ID is not obtained from a network device.

33. The method of claim 29, wherein to obtain the at least one ID, the method further comprises:
receiving a first configuration for the multi-path operation, the first configuration comprising a dedicated ID of the UE for the multi-path operation.

34. A network device for wireless communication, comprising:
at least one memory; and
at least one processor coupled with the at least one memory and operable to cause the network device to:
transmit at least one configuration for at least one identity (ID) of a user equipment (UE) associated with a multi-path operation; and
align the at least one ID for the multi-path operation.

35. A method performed by a network device, the method comprising:
transmitting at least one configuration for at least one identity (ID) of a user equipment (UE) associated with a multi-path operation; and
aligning the at least one ID for the multi-path operation.
